(19) United States
(12) Patent Application Publication
(10) Pub. No.: US 2003/0218855 A1
(43) Pub. Date: Nov. 27, 2003

(54) Ionization system with reduced power supply

(75) Inventor: Tony K. Goldenberg, Redondo Beach, CA (US)

Correspondence Address: MCDERMOTT, WILL & EMERY, 18191 VON KARMAN AVE., SUITE 500, IRVINE, CA, 92612-7108, US

(73) Assignee: Semtronics

(21) Appl. No.: 10/151,948

(22) Filed: May 22, 2002

(51) Int. Cl. H01G 2/00

(52) U.S. Cl. 361/213

(57) ABSTRACT

An ionization system for emitting positive and negative ions includes a first ionizer unit having at least one positive ion emitter, at least one negative ion emitter, a positive power supply connected to the at least one positive ion emitter, a negative power supply connected to the at least one negative ion emitter, a feedback control circuit for controlling power supplied by the positive and negative power supplies based on a feedback signal and an air outlet for emitting positive and negative ions from the positive and negative ion emitters. The system also includes a second ionizer unit having at least one positive ion emitter connected to the positive power supply of the first ionizer unit, at least one negative ion emitter connected to the negative power supply of the first ionizer unit, an air outlet for emitting positive and negative ions from the positive and negative ion emitters, an electrically conductive screen placed between the fan and the ion outlet, a variable voltage supply for supplying a variable voltage to the conductive screen and a sensor for detecting ion emission from the second ionizer unit, wherein the supply of power to the positive and negative ions emitters of the second ionizer unit is controlled by the feedback control circuit of the first ionizer unit.

### BACKGROUND OF THE INVENTION

1. Field of the Invention

The present invention relates to electrical static eliminators and, more particularly, to an area ionization system, which includes a first set of positive emitters and a second set of negative emitters, for providing a supply of positive and negative ions to a work area.

2. Description of the Related Art

Ionization systems are generally known and described, for example, in U.S. Pat. No. 4,974,115 to Breidegam, et al., which patent is commonly assigned with the present patent application and is expressly incorporated herein by reference. Other patents, such as U.S. Pat. No. 5,055,963 to Partridge and U.S. Pat. No. 5,183,811 to Rodrigo, et al. also disclose ionization systems of the general type disclosed herein and these patents are both expressly incorporated herein by reference. These systems simultaneously and continuously generate and supply positive and negative ions onto a work surface so as to eliminate static charge which could damage sensitive micro electronics. The supply of ions also reduce electrostatic attraction, foreign material contamination and other undesirable affects due to triboelectric charge generation in airborne particles.

Conventionally, and as disclosed in the patents mentioned above, ionization systems typically feature a number of tungsten needles or similar emitters which generate positively charged ions, negatively charged ions, or both. The ions produced by these emitters migrate to the work area and neutralize charges on the objects in the work area. The emitters are typically located overhead in or near the ceiling of the area and a curtain of moving air, typically provided by fans, helps transport the ions to the work area.

The area ionization systems, of the type disclosed in U.S. Pat. No. 4,974,115, include a steady state DC system having one or more ionizers which produces positive ions by a first set of emitters and negative ions by a second set of emitters which are energized contemporaneously with the first set of emitters. Each set of positive ion emitters are supplied by a positive high voltage supply and each set of negative ion emitters is provided with a negative high voltage power supply.

As shown in FIG. 1, conventional ionization system 1 includes three ionizers 2, 3 and 4. Each of the ionizers is identical in that each includes positive and negative emitters, 5 and 6, positive and negative high voltage power supplies 7 and 8, feedback circuitry 10 to maintain the output balance of positive and negative ions from the positive and negative emitters, fan 12 to transport the ions onto the work area, air inlet 13 and air outlet 14. For each ionizer in the ionization system, typically negative and positive ion emitters 5 and 6, includes one positive high voltage power supply for the positive emitters and one negative high voltage power supply for the negative ion emitters. As such, each ionizer requires at least two high voltage power supplies for supplying power to its respective negative and positive emitters.

Because each ionizer in the ionization system requires at least two power supplies, the cost of the ionization system increases as the number of ionizers within the ionization system increases. In addition, each ionizer within the ionization system requires, in the case of a non-grounded system, some type of feedback circuitry in order to maintain a balance of the positive and negative ions being emitted, further complicating the structure and adding further cost. An unbalanced ionizer will not produce the desired effect of properly eliminating electric static buildup on a work surface and, in some cases, may actually be more harmful to electronic components in the work area. Therefore, if the number of high voltage power supplies and the number of feedback circuitry can be reduced, the overall system cost and complexity will be reduced.

### SUMMARY OF THE INVENTION

The present invention addresses the drawbacks of the conventional systems by providing not only a balanced ionization system, but also an ionization system which reduces the number of power supplies required by using slaved ionizers which rely on the high voltage power supplies of a master ionizer and which are substantially balanced by the feedback circuitry of the master ionizer. Each slaved ionizer further includes a variable voltage-supplied screen which modifies the ion emissions from the slaved ionizers so as to complement the balancing provided by the feedback of the positive and negative emitters of the master ionizer.

According to one aspect of the invention, an ionization system for emitting positive and negative ions includes a first ionizer unit having at least one positive ion emitter, at least one negative ions emitter, a positive power supply connected to the at least one positive ion emitter, a negative power supply connected to the at least one negative ion emitter, a feedback control circuit for controlling power supplied by the positive and negative power supplies based on a feedback signal and an air outlet for emitting positive and negative ions from the positive and negative ion emitters. The system also includes a second ionizer unit having at least one positive ion emitter connected to the positive power supply of the first ionizer unit, at least one negative ion emitter connected to the negative power supply of the first ionizer unit, an air outlet for emitting positive and negative ions from the positive and negative ion emitters, and an electrically conductive screen placed between the fan and the ion outlet, a variable voltage supply for supplying a variable voltage to the conductive screen and a sensor for detecting ion emission from the second ionizer unit, wherein the supply of power to the positive and negative ions emitters of the second ionizer unit is controlled by the feedback control circuit of the first ionizer unit.

According to another embodiment, the present invention is an ionization system for generating and releasing a flow intermixed positive and negative ions which includes a first ionizer unit having a housing having an air inlet and an air outlet that is spaced apart from said inlet passage, a fan disposed in said housing to draw air into said housing through said air inlet for directing a flow of air through said air outlet, first and second ion emitters, disposed in said housing at a location in the air flow path between said air inlet and said fan, for producing positive ions from each of the first ion emitters and for producing negative ions from each of the second ion emitters, each of the emitters in said first and second ion emitters being oriented between the air inlet and the fan and being sufficiently spaced apart from the fan to enable air flow to carry the positive and negative ions away from respective ones of said first and second pairs of emitters and out of said housing through said air outlet, a high voltage supply connected to the first and second pairs of ion emitters for applying high DC voltage of positive polarity to each of the ion emitters of the first pair of emitters and for applying high DC voltage of negative polarity to each of the emitters of the second pair of emitters to produce supplies of both positive and negative ions, a feedback control circuit for controlling power supplied by the high DC voltage of positive polarity and the high DC voltage of negative polarity based on a feedback signal.

The system also includes a second ionizer unit having a housing having an air inlet and an air outlet that is spaced apart from said inlet passage, a fan disposed in said housing to draw air into said housing through said air inlet for directing a flow of air through said air outlet, first and second ion emitters disposed in said housing at a location in the air flow path between said air inlet and said fan for producing positive ions from each of the first ion emitters and for producing negative ions from each of the second ion emitters, each of the emitters in said first and second ion emitters being oriented between the air inlet and the fan and being sufficiently spaced apart from the fan to enable air flow to carry the positive and negative ions away from respective ones of said first and second pairs of emitters and out of said housing through said air outlet, the first pair of ion emitters being connected to the high DC voltage of positive polarity of the first ionizer unit and the second pair of ion emitters being connected to the high DC voltage of negative polarity, an electrically conductive screen placed between the fan and the air outlet, a variable voltage supply for supplying a variable voltage to the conductive screen and a sensor or detecting ion emission from the second ionizer unit, wherein the supply of high DC voltage of positive polarity connected to the first pair of ion emitters and the supply of high DC voltage of negative polarity connected to the second pair of ion emitters is controlled by the feedback control circuit of the first ionizer unit.

This brief summary of the invention has been provided so that the nature of the invention may be understood quickly. A more complete understanding of the invention can be obtained by reference to the following detailed description of the preferred embodiment(s) thereof in connection with the attached drawings.

### BRIEF DESCRIPTION OF THE DRAWINGS

FIG. 1 is a side schematic view of a conventional ionization system of having positive and negative high voltage power supplies for each ionizer's respective positive and negative emitters;

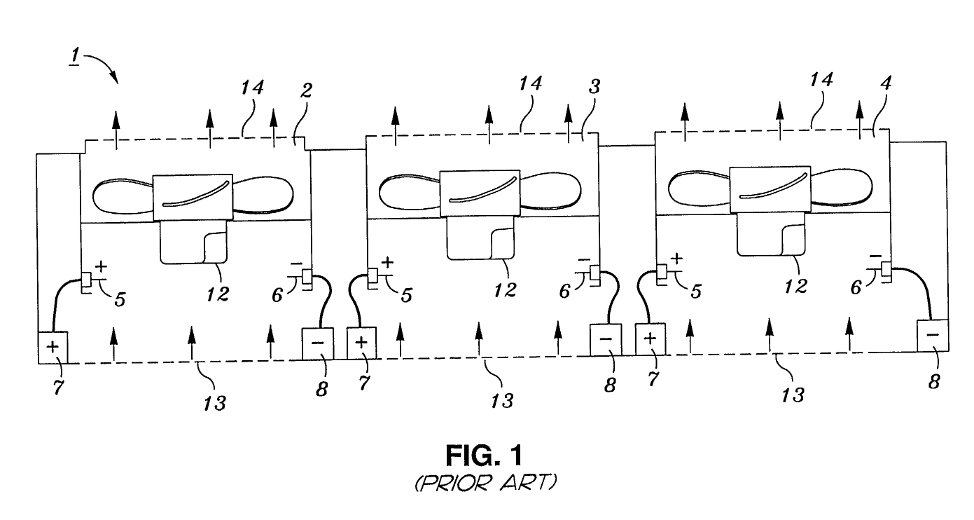

FIG. 2 is a side schematic view of an example of the ionization system constructed in accordance with the present invention, including a master ionizer unit and two slaved ionizer units;

FIG. 3 is a schematic view for explaining the master/slave arrangement of the ionizers in the ionization system; and

FIG. 4 is a schematic view illustrating the conductive screen placed in front of the air outlet of the slaved ionizer unit.

### DETAILED DESCRIPTION OF THE PREFERRED EMBODIMENT

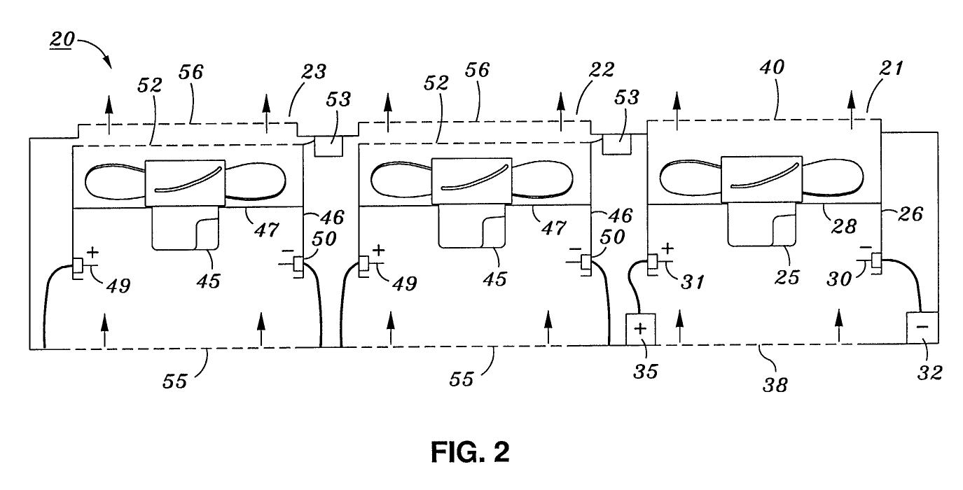

FIG. 2 is a schematic side view of the ionization system 20 according to the present invention. As shown in FIG. 2, the ionization system 20 includes three ionizer units 21, 22 and 23. Although ionization system 20 is depicted with three ionizer units, ionizer system may consist of at least two ionizer units, a master and slave unit, and is not limited to the number of ionizer units which could be included in the ionization system.

As shown in FIG. 2, ionization system includes master ionizer unit 21. Master ionizer unit 21 is similar in structure and circuitry as the ionization system disclosed in U.S. Pat. No. 4,974,115. Master ionizer unit 21 includes a fan or blower 25 located within housing 26 and held into housing by brackets 28. Implanted within housing wall 26 are positive and negative ion emitters 30 and 31, respectively. Negative emitter 30 is connected to a negative high voltage DC power supply 32 and positive emitter 31 is connected to a high voltage power DC supply 35. As discussed previously, the emitters 30 and 31 may be of a tungsten-type material or possibly graphic carbon or other appropriate material. Master ionizer unit 21 also includes air inlet 38, air outlet 40 which includes finger guard, and feedback control circuitry (not shown) which includes a sensor for sensing the combined output of negative ion emitter 30 and positive ion emitter 31 and a feedback loop which controls the output of power supplied by high voltage power supplies 32 and 35.

In operation, high voltage power supplies 32 and 35 provide high voltage to negative ion emitter 30 and positive ion emitter 31. Ions emitted by emitters 30 and 31 are transported out air outlet 40 by fan 25 so as to assist in the ion transport onto the work area. The positive and negative ion emissions are detected by a sensing unit in the feedback control circuitry. The feedback control circuitry balances positive and negative ions output from emitters 30 and 31 based on the sensing unit output. The sensors and feedback control circuitry are not shown in FIG. 2; however, such circuitry would be apparent to those who are skilled in the art and may be constructed in accordance with the ionization system disclosed in U.S. Pat. No. 4,974,115.

Ionization system 20 also includes two slaved ionizer units 22 and 23. In general, ionizer units 22 and 23 are slaved to master ionizer unit 21 since ionizer units 22 and 23 receive high voltage power for their emitters from negative high voltage power supply 32 and positive high voltage power supply 35 of master unit 21. Therefore, any change to the negative and positive ion emissions in master ionizer unit 21 is reflected in slaved ionizer units 22 and 23. Slaved ionizer units 22 and 23 have identical structures and elements. For the purpose of brevity, a description of slaved ionizer unit 23 will not be provided.

Slaved ionizer unit 22 includes a fan or blower 45 which is mounted within housing 46 and supported within housing 46 by brackets 47. Within housing 46 of slaved ionizer unit 22, there is implanted positive emitter 49 and negative emitter 50. Positive emitter 49 is connected to positive high voltage power supply 35 of master ionizer unit 21, and negative ion emitter 50 is connected to negative high voltage power supply 32 of master unit 21. Slaved ionizer unit 22 also includes a grid or screen 52 which is supplied with current from variable voltage supply 53. Slaved ionizer unit 22 also includes air inlet 55 and air outlet 56 which has a finger guard. By detecting the output of ions from slaved ionizer 22 using a sensor (not shown in FIG. 2), a voltage potential on screen 52 can be varied, with reference to earth ground, using variable voltage supply 53. The electrostatic field controls the balance of ions exiting slaved ionizer 22.

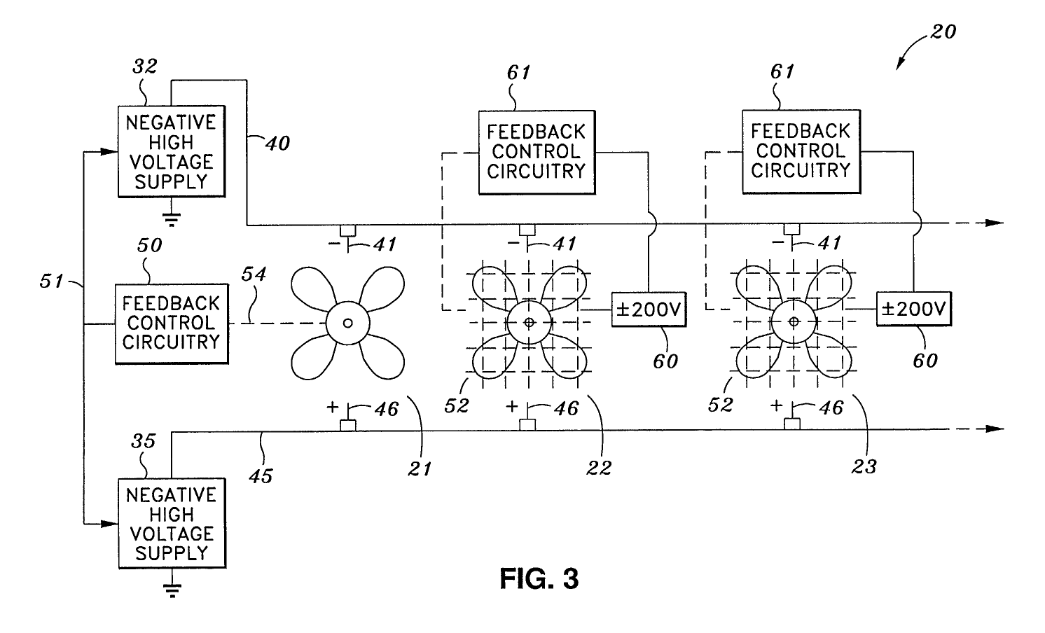

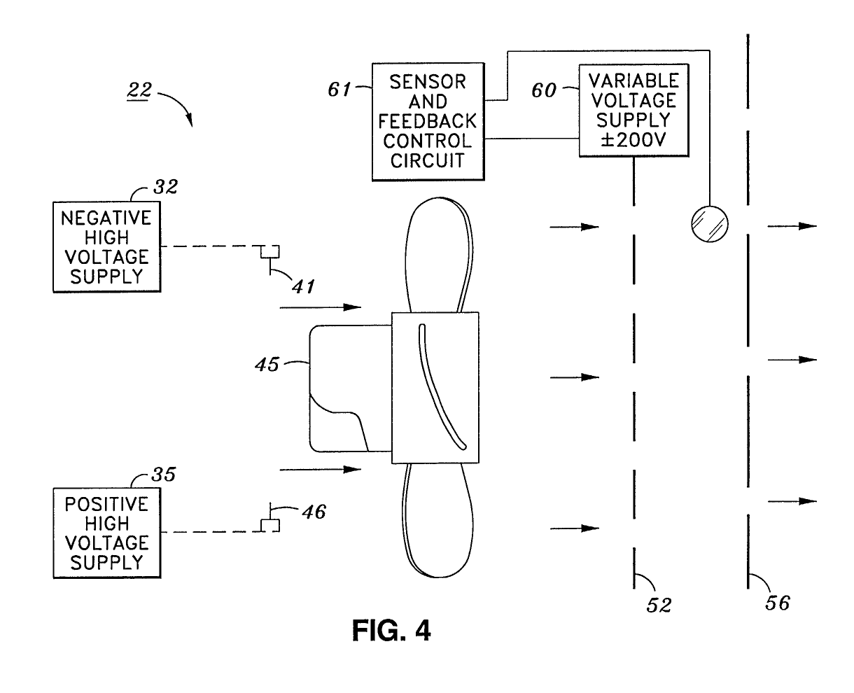

The operation of master/slaved ionizers in ionization system 20 will now be discussed with respect to FIGS. 3 and 4.

Now, with reference to FIG. 3, ionization system 20 comprises master ionizer unit 21 and a plurality of slaved ionizer units 22 and 23 (two slaved ionizer units are illustrated, although any number can be employed as desired, ranging from one on up, the number of slaved ionizer units depends on the voltage amount of the high voltage supply units). High voltage DC supply 32 supplies current to electrical line 40 to negative ion emitters 41 displayed in each ionizer unit 21, 22 and 23 so as to produce negative ions. Similarly, a second high voltage DC supply 35 supplies current through electrical line 45 to positive ion emitters 46 deployed in each ionizer unit 21, 22 and 23. Emitters 41 and 46 may be of the type generally known in the prior art, as disclosed in the aforementioned U.S. patents and they operate in a known manner to produce a state of “balanced ionization” wherein the negative and positive ions in the surrounding environment are in substantial balance and one to another. As disclosed in U.S. Pat. No. 4,974,115, for example, the steady balance supply of negative and positive ions allows faster charge decay rates within the work area, as well as reduced foreign matter contamination, and minimizes the possibility of harmful electrostatic discharge, which can damage or destroy components that are manufactured or handled in such work areas.

Master ionizer 21 further includes one or more feedback control circuitry 50, which is operatively connected, to control line 51 to high voltage DC supply 32 and 35. In addition, feedback control circuitry 50 includes a sensor for detecting the amount of ions emitted from emitters 41 and 46 within master ionizer unit 21. Feedback control circuitry 50 and feedback sensor 54 may be conventional, as disclosed in U.S. Pat. No. 4,974,115, for example, and operate in a conventional manner, as disclosed in that patent, to adjust the voltage on the emitters 41 and 46 via electrical lines 40 and 45 in order to adjust the supply of positive or negative ions, for the purpose of maintaining an ion balance, and thereby producing substantially zero voltage potential, in a work area below the master ionizer unit 21.

Although the preferred feedback control circuitry controls both positive and negative high voltage supplies providing current to both positive emitters 46 and negative emitters 41, the feedback circuit could just as easily maintain either a negative current supply constant and adjust the positive current supply or maintain the positive current supply constant and adjust the negative current supply. In this regard, negative ions migrate more easily, however, and adjustment of negative ion production accordingly causes a quicker and more efficient feedback process.

Referring now to FIGS. 3 and 4, slaved ionizer unit 22 receives positive and negative current supplied to its positive and negative emitters 41 and 46 from the negative high voltage supply 32 and positive high voltage supply 35 of master ionizer unit 21, respectively. In addition, the amount of current supplied to slaved ionizer unit 22 is controlled by master ionizer unit's feedback control circuitry 50. As such, slaved ionizer unit 22 receives power based on the feedback adjustments made with respect to master ionizer unit 21 and achieve a substantially ion balance. In other words, unlike prior art systems, the present invention does not require a separate power supply for each ionizer unit. Therefore, only master ionizer unit 21 need be so equipped with the high voltage power supplies. That is, the same adjustments made to power supplies supplying master ionizer unit 21, which is based upon conditions sensed in master ionizer unit 21 by sensor 54, are also applicable to improve acceptable levels of ionization balance within slaved ionizer units 22 and 23. In this fashion, a more efficient, less complex and less costly system can be designed using fewer voltage supplies. So long as the master ionizer unit produces balanced ionization, slaved ionizer units should produce balanced ionizations as well without feedback. The physical location of the master ionizer unit relative to slave ionizer units does not matter. That is, the master ionizer unit can be either in the middle of the slaved units or at one end or the other of the slave units.

To help further balance ionization emissions from the slaved ionizer units, slaved ionizer units 22 and 23 include screen 52 which is connected to a variable voltage supply such as a +/−200V variable voltage supply. That is, because the slaved ionizer units 22 and 23 do not have their own high voltage power supply and feedback control circuitry for controlling the high voltage power supply, slaved ionizer units 22 and 23 may have a somewhat different ionization balance than master ionizer unit 21, even though master ionizer unit 21 ion output is being balanced. Moreover, slaved ionizer units 22 and 23 will differ in balance from each other due to environment conditions, emitter contamination, or other reasons that effect ion output. As such, slaved ionizer units 22 and 23 each have conductive screens 52 which are connected to +/−200V variable voltage and sensor and feedback control circuitry 61 to control the variable voltage output to screen 52.

In reference to FIGS. 3 and 4, conductive screen 52, placed between fan 45 and air outlet 56 of slaved ionizer unit 22, can be used to control the balance of ionization produced by slaved ionizer unit 22. Specifically, variable voltage supply 60, illustrated in FIGS. 3 and 4, is provided and is electrically connected to screen 52. By detecting the ionization emitted from ionizer unit 22 using sensor and feedback control circuit 61, the voltage potential on screen 52 can be modified, plus or minus voltage with reference to earth ground, using a feedback signal provided by sensor and feedback control circuit 61 so as to further balance the ions exiting slaved ionizer unit 22.

Using the feedback control circuitry 50 and high voltage power supply of master ionizer unit 21 together with the electrically conductive screen 52 and its feedback circuitry 61 yields further benefits in being able to successfully achieve ionization balance in the slaved units. That is, to permit independent adjustment of an ionization balance in slaved ionizer units 22 and 23, relative to that in master ionizer unit 21, without utilizing separate feedback circuits and separate high voltage supplies for slaved ionizer units 22 and 23, DC bias voltage can be applied to screen 52 disposed at air outlet 56 of each slaved ionizer units 22 and 23, using a variable DC voltage supply like supply 60 shown in FIGS. 3 and 4. Adjustment of this biasing voltage will change the ionization balance in corresponding slaved ionizer units 22 and 23, without effecting the ionization balance in master ionizer unit 21.

Although an exemplary embodiment of the invention has been shown and described, it is to be understood that all terms used herein are descriptive rather than limiting and that many changes, modifications and substitutions may be made by one having ordinary skill in the art without departing from the spirit and scope of the invention. For example, although the disclosed improvements are useful with a “steady state DC” system, as disclosed in U.S. Pat. No. 4,974,115, they are also potentially applicable to other ionization systems, such as AC systems and pulsed DC systems. Moreover, although the slaved ionizers are disclosed herein as each having its own feedback system for controlling a variable voltage applied to its electrically conductive screen, an alternative embodiment may have slaved ionizers without a feedback system and/or a variable voltage applied to an electrically conductive screen to further balance the slaved ionizer.

What is claimed is:

1. An ionization system for emitting positive and negative ions, comprising:
a first ionizer unit comprising at least one positive ion emitter, at least one negative ion emitter, a positive power supply connected to the at least one positive ion emitter, a negative power supply connected to the at least one negative ion emitter, a feedback control circuit for controlling power supplied by the positive and negative power supplies based on a first feedback signal and an air outlet for emitting positive and negative ions from the positive and negative ion emitters; and
a second ionizer unit comprising at least one positive ion emitter connected to the positive power supply of the first ionizer unit, at least one negative ion emitter connected to the negative power supply of the first ionizer unit, an air outlet for emitting positive and negative ions from the positive and negative ion emitters, an electrically conductive screen placed between the fan and the ion outlet, a variable voltage supply for supplying a variable voltage to the conductive screen and a second feedback control circuit for detecting ion emission from the second ionizer unit and for controlling a variable voltage supplied to the electrically conductive screen,
wherein the supply of power to the positive and negative ions emitters of the second ionizer unit is controlled by the first feedback control circuit of the first ionizer unit.

2. An ionization system according to claim 1, wherein the first feedback control circuit includes a sensor for detecting ion emissions from the first ionizer unit and, based on the output of the sensor, the first feedback control unit controls power output by the positive power supply and the negative power supply so as to control the balance of ions emitted from the first ionizer unit and as a result also controls power supplied to the positive and negative ion emitters of the second ionizer unit.

3. An ionization system according to claim 1, wherein the second feedback control circuit includes a sensor which detects ion emissions in the second ionizer unit and the second feedback control circuit controls an output of variable voltage from the variable voltage supply to the conductive screen, based on the sensors detection, so as to control the balance of ions emitted from the second ionizer unit.

4. An ionization system according to claim 1, wherein each of the first ionizer unit and second ionizer unit are contained within a housing and wherein the first ionizer unit and the second ionizer unit further comprise a fan and a housing having an air inlet and an air outlet wherein the fan is disposed between the air inlet, the positive and negative ion emitters and the air outlet.

5. An ionization system for generating and releasing a flow intermixed positive and negative ions, comprising:
a first ionizer unit having a housing having an air inlet and an air outlet that is spaced apart from said inlet passage, a fan disposed in said housing to draw air into said housing through said air inlet for directing a flow of air through said air outlet, first and second ion emitters, disposed in said housing at a location in the air flow path between said air inlet and said fan, for producing positive ions from each of the first ion emitters and for producing negative ions from each of the second ion emitters, each of the emitters in said first and second ion emitters being oriented between the air inlet and the fan and being sufficiently spaced apart from the fan to enable air flow to carry the positive and negative ions away from respective ones of said first and second pairs of emitters and out of said housing through said air outlet, a high voltage supply connected to the first and second pairs of ion emitters for applying high DC voltage of positive polarity to each of the ion emitters of the first pair of emitters and for applying high DC voltage of negative polarity to each of the emitters of the second pair of emitters to produce supplies of both positive and negative ions, a feedback control circuit for controlling power supplied by the high DC voltage of positive polarity and the high DC voltage of negative polarity based on a feedback signal; and
a second ionizer unit having a housing having an air inlet and an air outlet that is spaced apart from said inlet passage, a fan disposed in said housing to draw air into said housing through said air inlet for directing a flow of air through said air outlet, first and second ion emitters disposed in said housing at a location in the air flow path between said air inlet and said fan for producing positive ions from each of the first ion emitters and for producing negative ions from each of the second ion emitters, each of the emitters in said first and second ion emitters being oriented between the air inlet and the fan and being sufficiently spaced apart from the fan to enable air flow to carry the positive and negative ions away from respective ones of said first and second pairs of emitters and out of said housing through said air outlet, the first pair of ion emitters being connected to the high DC voltage of positive polarity of the first ionizer unit and the second pair of ion emitters being connected to the high DC voltage of negative polarity, an electrically conductive screen placed between the fan and the air outlet, a variable voltage supply for supplying a variable voltage to the conductive screen and a second feedback control for detecting ion emission from the second ionizer unit and for controlling a variable voltage supplied to the electrically conductive screen,
wherein the supply of high DC voltage of positive polarity connected to the first pair of ion emitters and the supply of high DC voltage of negative polarity connected to the second pair of ion emitters is controlled by the first feedback control circuit of the first ionizer unit.

6. An ionization system according to claim 5, wherein the first feedback control circuit includes a sensor for detecting ion emissions from the first ionizer unit and, based on the output of the sensor, the feedback control unit controls power output by the high DC voltage supply and the high DC voltage supply so as to control the balance of ions emitted from the first ionizer unit and as a result also controls power supplied to the positive and negative ion emitters of the second ionizer unit.

7. An ionization system according to claim 5, wherein the second feedback control circuit includes a sensor for detecting ion emissions in the second ionizer unit and the second feedback control circuit controls an output of variable voltage from the variable voltage supply to the conductive screen so as to control the balance of ions emitted from the second ionizer unit.

8. An ionization system according to claim 5, wherein each of the first ionizer unit and second ionizer unit are contained within a housing of the ionization system.

9. An ionization system for emitting positive and negative ions, comprising:
a first ionizer unit comprising at least one positive ion emitter, at least one negative ion emitter, a positive power supply connected to the at least one positive ion emitter, a negative power supply connected to the at least one negative ion emitter, a first feedback control circuit for controlling power supplied by the positive and negative power supplies based on a feedback signal and an air outlet for emitting positive and negative ions from the positive and negative ion emitters; and
a second ionizer unit comprising at least one positive ion emitter connected to the positive power supply of the first ionizer unit, at least one negative ion emitter connected to the negative power supply of the first ionizer unit, and an air outlet for emitting positive and negative ions from the positive and negative ion emitters, wherein the supply of power to the positive and negative ions emitters of the second ionizer unit is controlled by the feedback control circuit of the first ionizer unit.

10. An ionization system according to claim 9, further comprising an electrically conductive screen placed between the fan and the ion outlet, a variable voltage supply for supplying a variable voltage to the conductive screen and a sensor for detecting ion emission from the second ionizer unit.

11. An ionization system according to claim 10, further comprising a second feedback control circuit for detecting ion emission from the second ionizer unit and for controlling a variable voltage supplied to the electrically conductive screen.

12. An ionization system according to claim 11, wherein the first feedback control circuit includes a sensor for detecting ion emissions from the first ionizer unit and, based on the output of the sensor, the first feedback control unit controls power output by the positive power supply and the negative power supply so as to control the balance of ions emitted from the first ionizer unit and as a result also controls power supplied to the positive and negative ion emitters of the second ionizer unit.

13. An ionization system according to claim 11, wherein the second feedback control circuit includes a sensor which detects ion emissions in the second ionizer unit and the second feedback control circuit controls an output of variable voltage from the variable voltage supply to the conductive screen, based on the sensors detection, so as to control the balance of ions emitted from the second ionizer unit.
